(19) United States
(12) Patent Application Publication
(10) Pub. No.: US 2012/0062446 A1
(43) Pub. Date: Mar. 15, 2012

(54) VIDEO IMAGE VIEWING GLASSES AND IMAGE DISPLAY SYSTEM

(75) Inventor: Nobuo SUGIYAMA, Suwa-shi (JP)

(73) Assignee: SEIKO EPSON CORPORATION, Tokyo (JP)

(21) Appl. No.: 13/223,551

(22) Filed: Sep. 1, 2011

(30) Foreign Application Priority Data
Sep. 9, 2010 (JP) 2010-202269

(51) Int. Cl. G09G 5/00

(52) U.S. Cl. 345/8

(57) ABSTRACT

A pair of video image viewing glasses comprising: a pair of image selection members each of which selects incident light and transmits the selected incident light; and a frame member in which the pair of image selection members are accommodated side by side. The pair of video image viewing glasses is used with or without another pair of glasses. The frame member includes: a locking portion via which the other pair of glasses locks the pair of video image viewing glasses when the pair of video image viewing glasses is worn over the other pair of glasses; and a nose pad provided to be positioned between the pair of image selection members. The nose pad is detachably attached to the frame member.

### BACKGROUND

1. Technical Field

The present invention relates to a pair of video image viewing glasses and an image display system.

2. Related Art

There has been a known image display system including an image display apparatus, such as a projector, and a pair of video image viewing glasses, such as glasses with built-in liquid crystal shutters.

In the image display system, a viewer wears the video image viewing glasses and views an image projected from the image display apparatus on a screen or any other suitable surface for stereoscopic image recognition.

The video image viewing glasses typically include a pair of image selection members formed, for example, of liquid crystal shutters and a frame member in which the pair of image selection members are accommodated (see JP-A-9-5904, for example).

The video image viewing glasses (liquid crystal shutter glasses) described in JP-A-9-5904, which can be used with another pair of glasses (regular glasses), include a nose pad on which a nose pad (eyeglass pad) of the other pair of glasses is put.

However, the video image viewing glasses described in JP-A-9-5904, when used with another pair of glasses, disadvantageously cause the other pair of glasses to be shifted upward from a normal position (where only the other pair of glasses is worn) by the thickness of the nose pad of the video image viewing glasses. Further, since the nose pad of the other pair of glasses is put on the nose pad of the video image viewing glasses, the other pair of glasses is disadvantageously shifted upward, downward, forward, or backward when the video image viewing glasses is put on unless the video image viewing glasses are configured to fit with the shape of the other pair of glasses, which may have a variety of shapes.

As described above, when the other pair of glasses is shifted, the centers of the lenses of the other pair of glasses are also shifted from those of the eyes of the viewer, resulting in a problem of degraded viewing performance.

### SUMMARY

An advantage of some aspects of the invention is to provide a pair of video image viewing glasses and an image display system that allow a viewer to use another pair of glasses and view an image comfortably.

An aspect of the invention is directed to a pair of video image viewing glasses including a pair of image selection members each of which selects incident light and transmits the selected incident light and a frame member in which the pair of image selection members are accommodated side by side. The pair of video image viewing glasses is used with or without another pair of glasses. The frame member includes a locking portion via which the other pair of glasses locks the pair of video image viewing glasses when the pair of video image viewing glasses is worn over the other pair of glasses, and a nose pad provided to be positioned between the pair of image selection members. The nose pad is detachably attached to the frame member.

Each of the image selection members that can select incident light and transmit the selected incident light may for example, be a liquid crystal shutter when the image selection members are used in what is called a pair of active video image viewing glasses. When the image selection members are used in what is called a pair of passive video image viewing glasses, each of the image selection members may, for example, be a polarizing filter. In the former case, incident light can be selected by opening and closing the liquid crystal shutter, whereas in the latter case, incident light can be selected in accordance with the polarization direction of the polarizing filter.

When the pair of video image viewing glasses is used with another pair of glasses in the embodiment of the invention, the nose pad is removed from the frame member before use. In this usage, when the video image viewing glasses are worn over the other pair of glasses, the other pair of glasses locks the locking portion. In other words, the other pair of glasses, which are stably worn by a viewer, locks the locking portion. The other pair of glasses will therefore not be shifted upward, downward, forward, or backward. Further, in this usage, since the video image viewing glasses are used with the nose pad removed from the frame member, the nose pad of the video image viewing glasses will not interfere with a nose pad of the other pair of glasses. The viewer can therefore view an image comfortably even when the video image viewing glasses are used with the other pair of glasses.

On the other hand, when the video image viewing glasses are used without the other pair of glasses, the nose pad is attached to the frame member before use. In this usage, the video image viewing glasses are stably worn by the viewer because the nose pad comes into contact with the nose of the viewer. The viewer can therefore view an image comfortably when the video image viewing glasses are used without the other pair of glasses as well.

In the video image viewing glasses according to the first aspect of the invention, the locking portion preferably blocks external light.

In the variation of the first aspect of the invention, since the locking portion has a light blocking capability, external light incident on the locking portion is blocked thereby or does not pass therethrough. External light will therefore not affect image light incident through the image selection members, whereby the viewer can view an image in a satisfactory manner.

Another aspect of the invention is directed to an image display system including any of the pair of video image viewing glasses described above and an image display apparatus that alternately displays a first image and a second image in a time division manner.

In the aspects of the invention, since the viewer views a first image and a second image alternately displayed by the image display apparatus through the shutter glasses described above, viewer's fatigue caused when viewing a stereoscopic image or any other similar image displayed by the image display apparatus can be reduced.

### BRIEF DESCRIPTION OF THE DRAWINGS

The invention will now be described with reference to the accompanying drawings, wherein like numbers reference like elements.

FIG. 1 is a perspective view showing how to use an image display system according to an embodiment of the invention.

FIG. 2 is a perspective view diagrammatically showing the configuration of video image viewing glasses in the embodiment.

FIG. 3 is a top view diagrammatically showing the configuration of the video image viewing glasses in the embodiment.

FIGS. 4A and 4B are side views diagrammatically showing how to use the video image viewing glasses in the embodiment.

### DESCRIPTION OF EXEMPLARY EMBODIMENTS

An embodiment of the invention will be described below with reference to the drawings.

### Configuration of Image Display System

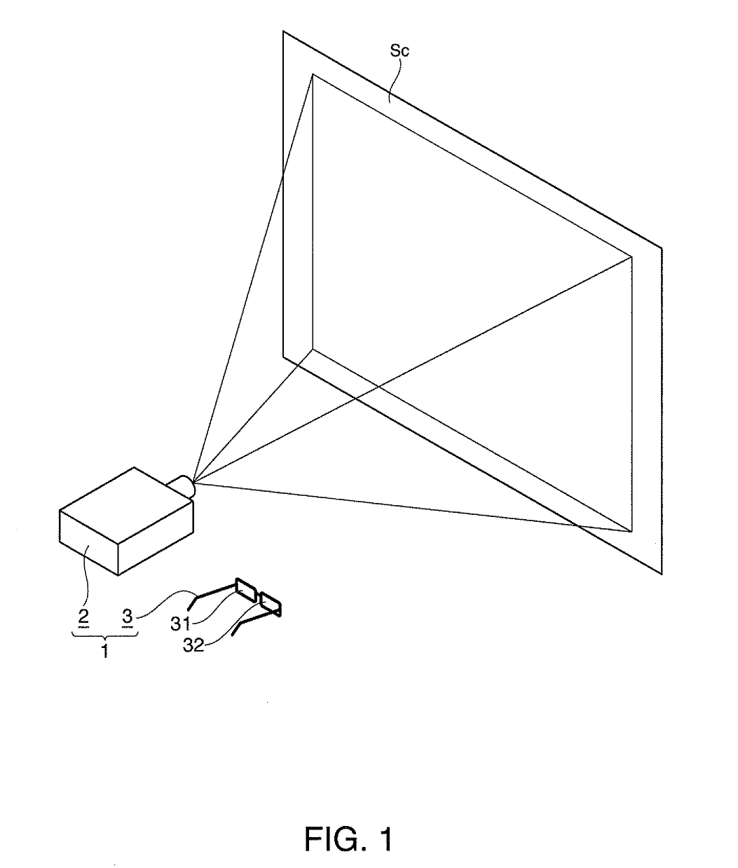

FIG. 1 is a perspective view showing how to use an image display system 1 according to the present embodiment.

The image display system 1 projects and displays an image on a reflective screen Sc and allows a viewer to view the projected image stereoscopically. The image display system 1 includes a projector 2 as an image display apparatus and a pair of liquid crystal shutter glasses 3 as a pair of video image viewing glasses, as shown in FIG. 1.

The projector 2 forms image light based on image information (image data) and projects the image light on the screen Sc. The projector 2 projects an image for the left eye (first image) and an image for the right eye (second image) in a time division manner or alternately in a fixed cycle. That is, an image for the left eye and an image for the right eye are alternately displayed on the screen Sc. The projector 2 supplies the liquid crystal shutter glasses 3 with a sync signal that allows them to recognize the timing when the images are switched.

The liquid crystal shutter glasses 3, which the viewer wears, include a selector for the left eye 31 and a selector for the right eye 32 (which will be described later) as a pair of image selection members, and the selectors 31 and 32 have the following states switchable from one to the other: a light transmitting state and a light blocking state.

The liquid crystal shutter glasses 3 receive the sync signal supplied from the projector 2 to recognize the timing when the projector 2 switches the displayed image between an image for the left eye and an image for the right eye and switch the states of the selector for the left eye 31 and the selector for the right eye 32 between the light transmitting state and the light blocking state in synchronization with the display switching operation.

That is, during a period when an image for the left eye is being displayed on the screen Sc, the selector for the left eye 31 transmits light and the selector for the right eye 32 blocks light. On the other hand, during a period when an image for the right eye is being displayed on the screen Sc, the selector for the right eye 32 transmits light and the selector for the left eye 31 blocks light.

The thus configured image display system 1 allows the viewer to visually recognize an image (image for the left eye) projected on the screen Sc only with the left eye and an image (image for the right eye) projected on the screen Sc only with the right eye. The viewer therefore stereoscopically views the images projected on the screen Sc with the aid of parallax.

### Configuration of Liquid Crystal Shutter Glasses

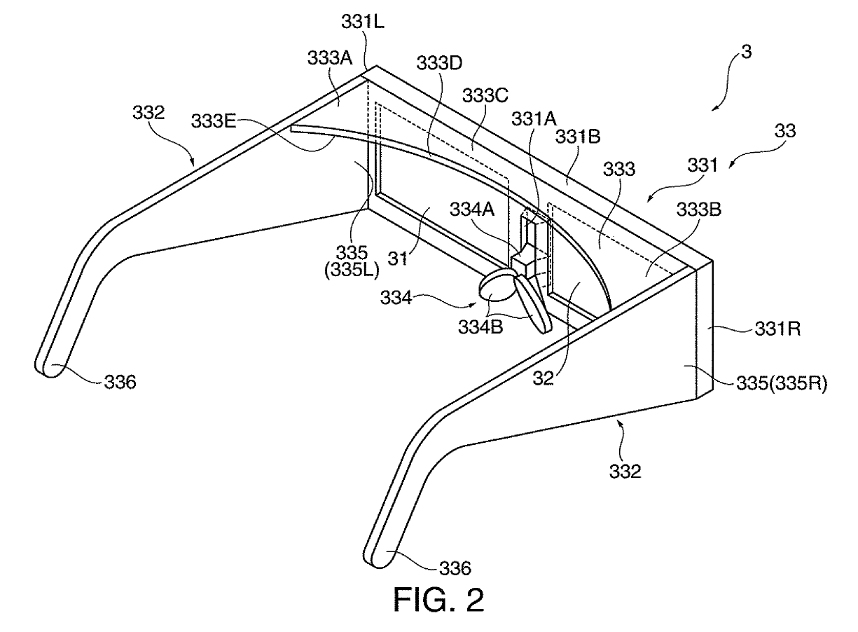

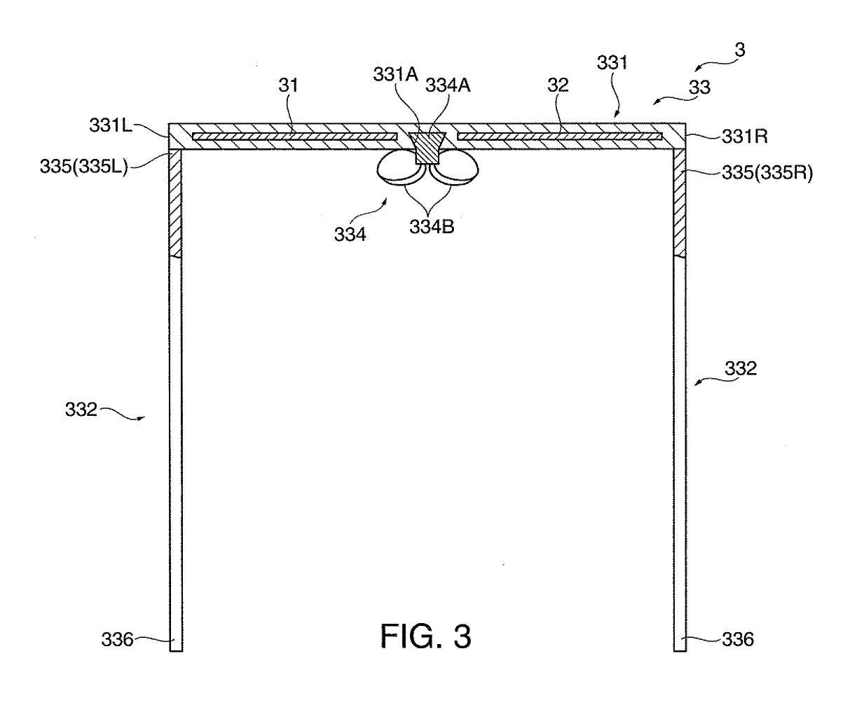

FIGS. 2 and 3 are diagrammatic views showing the configuration of the liquid crystal shutter glasses 3. Specifically, FIG. 2 is a perspective view of the liquid crystal shutter glasses 3, and FIG. 3 is a top view of the liquid crystal shutter glasses 3. FIG. 3 is also a partially cutaway view of the liquid crystal shutter glasses 3 in which a front portion thereof is cut away and the cutaway portion is hatched.

The liquid crystal shutter glasses 3 include the selector for the left eye 31, the selector for the right eye 32, and a frame member 33, as shown in FIGS. 2 and 3.

Each of the selector for the left eye 31 and the selector for the right eye 32 is formed of what is called a liquid crystal shutter, and the state thereof is switched between the light transmitting state, in which the selector transmits light, and the light blocking state, in which the selector blocks light, as described above. That is, each of the selector for the left eye 31 and the selector for the right eye 32 is configured to open and close the liquid crystal shutter so that the selector selectively transmits light incident thereon. The selector for the left eye 31 and the selector for the right eye 32 are assembled side by side and have as a whole a flat plate shape, as shown in FIGS. 2 and 3, as in the case of eyeglass lenses of a pair of glasses for diopter correction.

As shown in FIGS. 2 and 3, the frame member 33 includes a rim 331, a pair of temples 332, a locking portion 333 (FIG. 2), and a nose pad 334 and has a substantially U-like shape in a top view (FIG. 3).

The rim 331 connects the selector for the left eye 31 and the selector for the right eye 32 to each other and holds them. The rim 331 has a recessed groove 331A formed at a central portion where the selector for the left eye 31 and the selector for the right eye 32 are connected to each other, as shown in FIG. 2, and the recessed groove 331A has a substantially trapezoidal cross-sectional shape and extending downward. Specifically, the recessed groove 331A is so configured that the width thereof increases toward the bottom thereof.

The rim 331 is also provided with an infrared light receiving device or any other light receiver (not shown) that receives the sync signal described above.

Each of the temples 332 has an elongated triangular shape and has a base end 335, which is one end of the temple 332, connected to the rim 331, as shown in FIGS. 2 and 3. Specifically, a left base end 335L is connected to a left edge 331L of the rim 331, and a right base end 335R is connected to a right edge 331R of the rim 331. Each of the temples 332 has a free end 336, which is the other end of the temple 332, bent downward and has a substantially L-like shape. The temples 332 are so connected to the rim 331 that they are substantially perpendicular to the selector for the left eye 31 and the selector for the right eye 32, which are held by the rim 331 and assembled side by side in a flat plate shape, in the side view and the top view as shown in FIGS. 2 and 3.

The locking portion 333 has a flat plate shape and has a light blocking capability. The light blocking capability is achieved, for example, by forming the locking portion 333 with a material having a light blocking property or applying a light blocking material onto the surface of the locking portion 333. The locking portion 333 has a left edge 333A and a right edge 333B attached to the left temple 332 and the right temple 332, respectively. The locking portion 333 further has an edge 333C, which is one end of the locking portion 333, attached to the rim 331 along an upper edge 331E thereof. Further, the locking portion 333 has an edge 333D, which is the other end of the locking portion 333, having an arcuate shape concave with respect to the center in the longitudinal direction (right-left direction), as shown in FIG. 2.

The locking portion 333 further has a lower surface 333E having a slip prevention capability so that the lower surface 333E is not slippery. The slip prevention capability is achieved, for example, by forming the locking portion 333 with silicon, styrene, or any other suitable rubber material or polyethylene or any other suitable plastic material. The slip prevention capability is alternatively achieved, for example, by attaching an adhesive tape made of an embossed fabric material.

The nose pad 334, which is a portion where the liquid crystal shutter glasses 3 worn by the viewer are supported by the nose thereof, includes an engaging portion 334A and a nose supporting portion 334B, as shown in FIGS. 2 and 3. The nose pad 334 is attached to the frame member 33 to be positioned between the selector for the left eye 31 and the selector for the right eye 32.

The engaging portion 334A has a tapered shape that fits in the recessed groove 331A in the rim 331, as shown in FIG. 3. The engaging portion 334A engages with the recessed groove 331A in a movable manner upward and downward along the recessed groove 331A and can be attached and detached to and from the recessed groove 331A. The engaging portion 334A, when fitting in the recessed groove 331A having a width increasing toward the bottom thereof, unlikely disengages from the recessed groove 331A.

The nose supporting portion 334B is a portion with which the nose of the viewer who wears the liquid crystal shutter glasses 3 comes into contact. The nose supporting portion 334B is attached to the engaging portion 334A in the vicinity of the apex thereof.

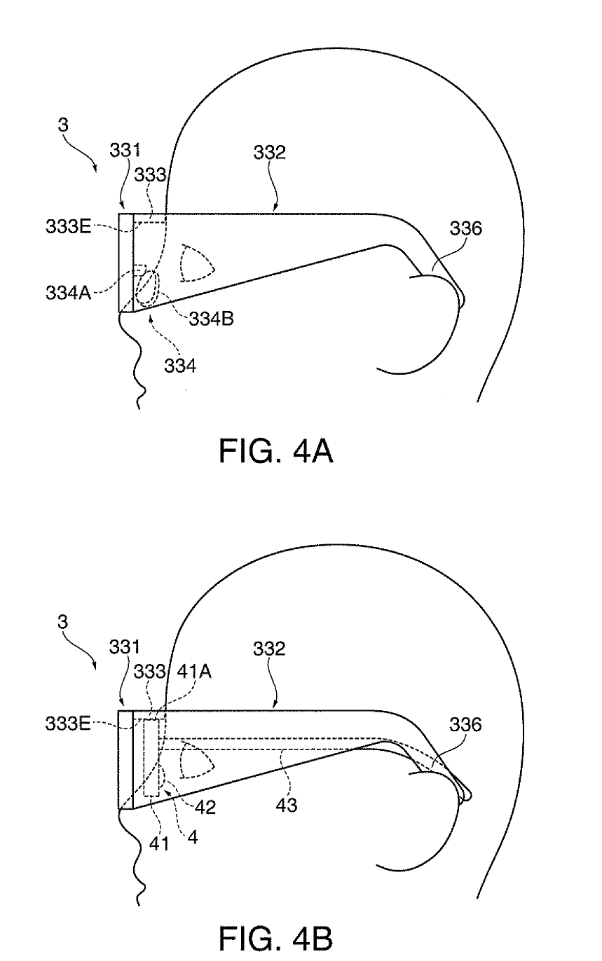

FIGS. 4A and 4B are side views showing how to use the liquid crystal shutter glasses 3. Specifically, FIG. 4A shows how to use the liquid crystal shutter glasses 3 that are the only glasses worn by the viewer. FIG. 4B shows how to use the liquid crystal shutter glasses 3 that the viewer wears over another pair of glasses 4 for diopter correction or other purposes.

When the viewer wears only the liquid crystal shutter glasses 3, the nose pad 334 is attached to the rim 331 before use, as shown in FIG. 4A. That is, the engaging portion 334A is fit into the recessed groove 331A.

In this usage, when the viewer wears the liquid crystal shutter glasses 3, the nose pad 334 is supported by the nose of the viewer, and the free ends 336 of the temples 332 are supported by the ears of the viewer.

On the other hand, when the viewer wears the liquid crystal shutter glasses 3 over the other pair of glasses 4, the nose pad 334 is removed from the rim 331 before use, as shown in FIG. 43.

In this usage, when the viewer wears the liquid crystal shutter glasses 3, the other pair of glasses 4 locks the locking portion 333. Specifically, the lower surface 333E of the locking portion 333 of the liquid crystal shutter glasses 3 comes into contact with an upper edge 41A of a rim 41 of the other pair of glasses 4 as shown in FIG. 4B, whereby the other pair of glasses 4 locks the liquid crystal shutter glasses 3.

In this usage, when the viewer wears the liquid crystal shutter glasses 3, the other pair of glasses 4 locks the locking portion 333. In this case, the liquid crystal shutter glasses 3 are therefore so worn that the locking portion 333 is supported by the nose of the viewer via the other pair of glasses 4 and the free ends 336 of the temples 332 are supported by the ears of the viewer.

The embodiment described above provides the following advantageous effects.

When the liquid crystal shutter glasses 3 are used with the other pair of glasses 4 and worn over the other pair of glasses 4, the other pair of glasses 4 locks the locking portion 333. In other words, the other pair of glasses 4, which is stably worn by the viewer, locks the locking portion 333. The other pair of glasses 4 will therefore not be shifted upward, downward, forward, or backward. Further, in this usage, since the liquid crystal shutter glasses 3 are used with the nose pad 334 removed from the frame member 33, the nose pad 334 of the liquid crystal shutter glasses 3 will not interfere with a nose pad 42 of the other pair of glasses 4. The viewer can therefore view an image comfortably even when the liquid crystal shutter glasses 3 are used with the other pair of glasses 4.

On the other hand, when the liquid crystal shutter glasses 3 are used without the other pair of glasses 4, the nose pad 334 is attached to the frame member 33 before use. In this usage, the liquid crystal shutter glasses 3 are stably worn by the viewer because the nose pad 334 comes into contact with the nose of the viewer. The viewer can therefore view an image comfortably when the liquid crystal shutter glasses 3 are used without the other pair of glasses 4 as well.

Since the viewer views an image displayed from the projector 2 on the screen Sc through the thus configured liquid crystal shutter glasses 3, viewer's fatigue caused when viewing the displayed image can be reduced.

Further, since the locking portion 333 has a light blocking capability, external light incident on the locking portion 333 is blocked thereby or does not pass therethrough. External light will therefore not affect image light incident on the eyes of the viewer through the selector for the left eye 31 and the selector for the right eye 32, whereby the viewer can view an image in a satisfactory manner. The external light used herein is light other than image light, such as illumination light and sunlight.

Moreover, when the liquid crystal shutter glasses 3 are used with the other pair of glasses 4, the weight of the two pairs of glasses acts on the nose of the viewer at only one location where the nose pad 42 of the other pair of glasses 4 comes into contact with the nose of the viewer, whereby the viewer can more comfortably wear the two pair of glasses than in a case where the weight of the liquid crystal shutter glasses 3 and the weight of the other pair of glasses 4 act on separate locations on the nose.

Further, when the liquid crystal shutter glasses 3 are used without the other pair of glasses 4, the nose pad 334 can be detached and any other nose pad 334 that fits with the viewer can be selected and attached, whereby the viewer can wear the liquid crystal shutter glasses 3 in the most comfortable manner. Moreover, since the engaging portion 334A is movable along the recessed groove 331A, the viewer can adjust the engaging portion 334A in such a way that the selector for the left eye 31 and the selector for the right eye 32 are positioned appropriately along the line of sight.

The invention is not limited to the embodiment described above. Changes, improvements, and other modifications can be made to the extent that the advantage of some aspects of the invention is achieved, and these changes, improvements, and other modifications fall within the scope of the invention.

In the embodiment described above, when the liquid crystal shutter glasses 3 are used with the other pair of glasses 4, the locking portion 333 is so positioned that the upper edge 41A of the rim 41 of the other pair of glasses 4 locks the locking portion 333. The locking portion 333 is not necessarily positioned this way, but may, for example, be so positioned that temples 43 of the other pair of glasses 4 (FIG. 4B) lock the locking portion 333. Further, the locking portion 333 does not necessarily have the shape and the size shown in the embodiment described above but may, for example, have a convex shape protruding from the frame member 33.

In the embodiment described above, the image display system according to the embodiment of the invention is the image display system 1 that allows the viewer to view a projected image stereoscopically but the image display system is not necessarily configured this way. For example, an image for the left eye and an image for the right eye may have contents different from each other, and a dual display system that projects and displays the two images may be provided.

When the image display system is configured as the dual display system described above, the liquid crystal shutter glasses 3 may be replaced with the following two types of glasses: a pair of glasses having the selector for the left eye 31 provided on both sides and a pair of glasses having the selector for the right eye 32 provided on both sides.

In the embodiment described above, the image display system 1 has been described only with reference to the front projection projector 2. The invention may alternatively be applied to an image display system including a screen and a rear projection projector that projects an image through the rear side of the screen. Still alternatively, the invention may be applied to an image display system using a television receiver, a computer monitor, or any other suitable apparatus as the image display apparatus.

In the embodiment described above, the video image viewing glasses according to the embodiment of the invention are the liquid crystal shutter glasses 3, which are of active type using liquid crystal shutters, but the video image viewing glasses are not necessarily configured this way. The invention may be applied to video image viewing glasses employing other principles. For example, the invention may be applied to passive video image viewing glasses including polarizing filters that select image light carrying a first image and image light carrying a second image, the first and second images having two different polarization directions produced in an image display apparatus, and allow the selected image light to be incident on the glasses. In this case, the polarizing filters may be used as the pair of image selection members.

The invention can be used with an image display system that includes a projector and a pair of glasses and allows a viewer to view an image stereoscopically.

The entire disclosure of Japanese Patent Application No. 2010-202269, filed Sep. 9, 2010 is expressly incorporated by reference herein.

What is claimed is:

1. A pair of video image viewing glasses comprising:
a pair of image selection members each of which selects incident light and transmits the selected incident light; and
a frame member in which the pair of image selection members are accommodated side by side,
wherein the pair of video image viewing glasses is used with or without another pair of glasses,
the frame member includes
a locking portion via which the other pair of glasses locks the pair of video image viewing glasses when the pair of video image viewing glasses is worn over the other pair of glasses, and
a nose pad provided to be positioned between the pair of image selection members, and
the nose pad is detachably attached to the frame member.

2. The pair of video image viewing glasses according to claim 1,
wherein the locking portion blocks external light.

3. An image display system comprising:
the pair of video image viewing glasses according to claim 1; and
an image display apparatus that alternately displays a first image and a second image in a time division manner.

4. An image display system comprising:
the pair of video image viewing glasses according to claim 2; and
an image display apparatus that alternately displays a first image and a second image in a time division manner.
